(19) United States
(12) Patent Application Publication
(10) Pub. No.: US 2026/0021544 A1
(43) Pub. Date: Jan. 22, 2026

(54) Press Ring, Press Collar and Pressing Tool With Adjustment Element

(71) Applicant: Marcel Vetter, Wuppertal (DE)

(72) Inventor: Marcel Vetter, Wuppertal (DE)

(21) Appl. No.: 18/877,426

(22) PCT Filed: Jun. 21, 2023
(86) PCT No.: PCT/EP2023/066832

§ 371 Date: Dec. 20, 2024

(30) Foreign Application Priority Data
Jun. 21, 2022 (DE) 10 2022 115 433.5

(51) Int. Cl. B23P 19/02

(52) U.S. Cl. CPC B23P 19/02

(57) ABSTRACT

A press ring, to a press collar, to a pressing tool, to a pressing device, which has an electric drive and a pressing tool according to the invention, to a system, which has a press ring according to the invention or a press collar according to the invention and a pressing device according to the invention, for pressing a press fitting. The press ring for pressing a press fitting has at least two segments, which are movably interconnected by means of at least one connecting element, the segments being movable from an open position into a closed position, and the press ring has at least one adjustment element, the adjustment element being designed to adjust the at least two segments into any position between the open position and the closed position.

### CROSS-REFERENCE TO RELATED APPLICATIONS

This application is the United States national phase of International Application No. PCT/EP2023/066832 filed Jun. 21, 2023, and claims priority to German Patent Application No. 10 2022 115 433.5 filed Jun. 21, 2022, the disclosures of which are hereby incorporated by reference in their entireties.

### BACKGROUND OF THE INVENTION

### Field of the Invention

The present invention relates to a press ring, to a press collar, to a pressing tool, to a pressing device, which has an electric drive and a pressing tool according to the invention, to a system which has a press ring according to the invention or a press collar according to the invention and a pressing device according to the invention, for pressing a press fitting.

When pressing press fittings, in particular for the connection of tubular components by means of cold forming, it is known to use a press ring. The press ring has at least two segments which are connected to each other in a hinge-like manner and in turn each have receiving elements for connection to a pressing tool. The press ring is connected to a pressing device by means of a pressing tool which in turn has pressing jaws with connecting elements for connection with the receiving elements of the press ring. This allows a mechanical pressing force to be applied by the pressing device to the press ring for pressing the press fitting. In particular, this is an electrohydraulic pressing device by which the pressing jaws of the pressing tool are moved towards each other, the movement of the pressing jaws being transmitted to the press ring to close the press ring, as a result of which a reduction of an inner radius of the press ring occurs, by which the press fitting abutting the inner radius of the press ring is pressed.

To press the press fitting, however, the press ring, the press collar and/or the pressing tool must first be placed around the press fitting and positioned precisely at the point to be pressed. For this purpose, the press ring, the press collar and/or the pressing tool in the prior art must be moved from an initial position to a corresponding opening position by applying force and must be held until the press ring/the press collar is positioned at the desired point on the press fitting for pressing.

Known press rings or press collars, consisting of at least two press ring segments, are typically moved automatically from the open to the closed position by at least one spring element, in particular a torsion spring.

### Description of Related Art

However, one problem with known press rings or press collars is that it is only possible to set and hold the press ring in the desired position by applying a force against the spring force of the spring element, making it difficult to operate the press ring and/or precisely position the press ring at the point of the press fitting to be pressed. In particular, both hands of the user are required so that it is not possible, for example, to hold the press fitting. Even in inaccessible places, it is sometimes not possible to hold the press ring in the open position with both hands until it has been placed around the press fitting.

### SUMMARY OF THE INVENTION

The object of the present invention is to provide a press ring, a press collar and a pressing tool which solve the above-mentioned problems and thus facilitate and improve operability and increase the precision of the pressing operation.

The problem is solved by a press ring as described herein, a press collar as described herein, a pressing tool as described herein, a pressing device as described herein with an electric drive and a pressing tool according to the invention, and a system as described herein with a press ring according to the invention or a press collar according to the invention with a drive.

A first aspect of the present invention relates to a press ring for pressing a press fitting. In this case, the press ring has at least two segments movably connected to one another through at least one connecting element, the segments being movable from an open position to a closed position. In particular, the connecting element defines an axis of rotation for the movement of the two segments in relation to each other. Furthermore, the press ring has at least one adjustment element, the adjustment element being designed to adjust the at least two segments to any position between the open position and the closed position. This allows the segments of the press ring to be adjusted to any position and, in particular, to be positioned and held in this position without force. In this position, the press ring can then be placed around a press fitting without having to apply additional force to hold the segments in the desired position. This allows for easier and more precise positioning of the press ring on the press fitting, which simplifies the operation of the press ring and improves the precision of the pressing process. Furthermore, the press ring can be securely attached even in areas that are difficult to access.

A second aspect of the present invention relates to a press collar for pressing a press fitting. The press collar has at least three or more segments, with the first segment being movably connected to the second segment via at least one first connecting element and being able to be moved from an open position to a closed position. Furthermore, the third segment is movably connected to the second segment via at least one second connecting element in order to be moved from an open position to a closed position. In particular, the connecting elements define an axis of rotation for the movement of the neighboring segments in relation to each other. Furthermore, the press collar has at least one adjustment element, the adjustment element being designed to adjust the first segment or the third segment relative to the second segment to any position between the open position and the closed position. This allows the segments of the press collar to be adjusted to any position and, in particular, to be held in this position without force. In this position, the press collar can then be placed around a press fitting without having to apply additional force to hold the segments in the desired position. This allows for easier and more precise positioning of the press collar on the press fitting, which simplifies the operation of the press collar and improves the precision of the pressing process. Furthermore, the press collar can be securely attached even in areas that are difficult to access.

Preferably, the press collar has at least two adjustment elements. In particular, the at least two adjustment elements can be of the same or different design. This makes it possible to equip the press collar with more than one type of adjustment element, which further increases the adaptability of the press collar to different fields of application and/or requirements.

Preferably, the press collar has more than three segments, with an adjustment element being arranged on each connecting element between every two segments. The adjustment elements can be of the same or different design.

Preferably, the adjustment element according to the first or second aspect of the present invention is configured to generate an axial force along the connecting element, wherein the axial force presses an axial surface of the first segment onto an axial surface of the second segment to hold the two segments in any position by the friction of the first axial surface with the second axial surface without any force having to be applied by the user. In particular, several axial forces can act on several axial surfaces of the first or second segment, especially those that are different from one another, in order to hold the respective axial surfaces of the first segment in a freely selectable position with those of the second segment by means of friction. The friction is adapted or dimensioned in such a way that a frictional connection or non-positive connection is created between the adjustment element and the two segments to hold the two segments in any position between an open position and a closed position. The axial force acting along the connecting element thus prevents mutual displacement of the two segments as long as the static friction force acting between the adjustment element and the axial surfaces of the first and/or second segment due to static friction is greater than a closing force applied by the user in particular. This enables particularly simple, especially one-handed and flexible adjustment and stable holding of the press ring or press collar in any position between an open and closed position.

Preferably, the adjusting element according to the first or second aspect of the present invention is arranged between one of the two segments and one end of the connecting element. In particular, the adjustment element is only in direct, especially axial, contact with one of the two segments. This leaves the area between the two segments free, allowing the segments to be arranged as close together as possible in the axial direction or the free area can be used to accommodate other components if required. In particular, this also makes it possible to replace the adjustment element without dismantling the segments of the press ring or the press collar.

Preferably, the adjustment element according to the first or second aspect of the present invention is arranged between the two segments. In particular, the adjustment element is in direct, especially axial, contact with both segments. This means that the adjustment element is secured between the two segments of the press ring or press collar without any further fixing or adjustment components.

Preferably, the adjustment element according to the first or second aspect of the present invention is a spring element and in particular a disk spring, a compression spring, a wave spring, a flat spring and in particular a disk-shaped flat spring, an O-ring or an elastomer. This means that the adjustment element can be made available in a simple and cost-effective way.

Preferably, according to the first or second aspect of the present invention, the adjustment element at least partially surrounds the respective connecting element.

Preferably, the adjustment element according to the first or second aspect of the present invention is a screw element, wherein the screw element is detachably connected to the connecting element and in particular is arranged at one end of the connecting element. In particular, the screw element is arranged on an outer surface of one of the two segments. In this way, the screw element simultaneously serves as an adjustment element for holding the segments of the press ring or the press collar in the desired position and as a fixing element for fixing the two segments, which are detachably connected to the connecting element, to the connecting element.

A third aspect of the present invention relates to a pressing tool for pressing a press fitting in particular by means of a press ring. The pressing tool has two pressing jaws, wherein the first pressing jaw is arranged rotatably about a first axis of rotation and wherein the second pressing jaw is arranged rotatably about a second axis of rotation, wherein the axes of rotation are connected by a lug and wherein the pressing jaws can be moved towards one another from an open position into a closed position for pressing. Furthermore, the pressing tool has at least one adjustment element, the adjustment element being designed to adjust the first pressing jaw and/or the second pressing jaw to any position between the open position and the closed position. This means that an adjustment element can be provided for the first pressing jaw. Alternatively, an adjustment element can be provided for the second pressing jaw. Alternatively, an adjustment element is provided for both the first pressing jaw and the second pressing jaw. Here, the two adjustment elements can be identical or different in design. This simplifies the operation of the pressing tool and improves the precision of the pressing process.

Preferably, the first and/or second axis of rotation is designed as a bolt.

Preferably, the adjustment element is designed to generate an axial force along the respective axis of rotation, whereby the axial force presses an axial surface of the pressing jaw onto an axial surface of the lug, whereby the pressing jaw is held in the desired position by the friction of the first axial surface with the second axial surface. In particular, several axial forces can act on several axial surfaces of the pressing jaw, especially those that are different from one another, in order to hold the respective axial surfaces in any position with those of the lug by means of friction. The friction is adapted or dimensioned in such a way that a frictional connection or non-positive connection is created between the adjustment element and the first or second pressing jaw to hold the pressing jaw in any position between an open position and a closed position. The axial force acting along the respective axis of rotation thus prevents unintentional opening and/or closing of the pressing jaw as long as the static friction force acting between the adjustment element and the axial surfaces of the pressing jaw due to static friction is greater than a closing force applied by the user in particular. This enables simple, especially one-handed and flexible adjustment and stable holding of the pressing tool in any position between an open and closed position.

Preferably, the adjustment element is arranged between one of the two pressing jaws and the lug. In particular, the adjustment element is in direct contact with both the lug and one of the two pressing jaws. As a result, the adjustment element is secured between the lug and a pressing jaw of the pressing tool without any further fixing or adjustment components.

Preferably, the adjustment element is arranged between one end of the respective axis of rotation and the lug. In particular, the adjustment element is only in direct contact with the lug and, in particular, with the axis of rotation in the form of a bolt. This makes it easy to replace the adjustment element.

Preferably, the adjustment element is a spring element and in particular a disk spring, a compression spring, a wave spring, a flat spring and in particular a disk-shaped flat spring, an O-ring or an elastomer. This means that the adjustment element can be made available in a simple and cost-effective way.

Preferably, the adjustment element at least partially surrounds the respective axis of rotation.

Preferably, the adjustment element is a screw element, wherein the screw element is detachably connected to the respective axis of rotation and, in particular, is arranged at one end of the axis of rotation, in particular on an outer surface of one of the two pressing jaws. In this way, the screw element simultaneously serves as an adjustment element for holding the pressing jaws of the pressing tool in the desired position and as a fixing element for fixing the two pressing jaws, which are detachably connected to the connecting element, to the connecting element.

A fourth aspect of the present invention relates to a pressing device with an electric drive and a pressing tool according to the third aspect of the present invention. The pressing tool is connected to the drive to move the pressing jaws of the pressing tool. This provides a pressing device that allows the pressing jaws to be held in any position in a stepless manner.

A fifth aspect of the present invention relates to a system comprising a press ring or press collar according to the first or second aspect and, in particular, a pressing device according to the fourth aspect of the present invention comprising a drive. This provides a system that enables stepless adjustment to any position and holding in the steplessly adjustable position.

### BRIEF DESCRIPTION OF THE DRAWINGS

The terms Fig., Figs., Figure, and Figures are used interchangeably to refer to the corresponding figures in the drawings.

In the following, the invention is described in more detail by means of preferred embodiments with reference to the accompanying drawings.

In the Figures:

FIG. 1A is a top view of a press ring according to the invention,

FIG. 1B is a front view of the press ring according to the invention in a closed position,

FIG. 1C is a front view of the press ring according to the invention in several positions between the open position and the closed position,

FIG. 1D is a front view of the press ring according to the invention in the open position with a press fitting,

FIG. 1E is a top view of an embodiment of the press ring according to the invention,

FIG. 1F is a top view of a further embodiment of the press ring according to the invention,

FIG. 1G is a top view of a further embodiment of the press ring according to the invention,

FIG. 1H is a top view of a further embodiment of the press ring according to the invention,

FIG. 1I is a top view of a further embodiment of the press ring according to the invention,

FIG. 1J is a top view of a further embodiment of the press ring according to the invention,

FIG. 2A shows a press collar according to the invention,

FIG. 2B is a front view of the press collar of FIG. 2,

FIG. 2C is a lateral view of the press collar of FIG. 2,

FIG. 3 is a front view of a pressing tool according to the invention with a press ring.

### DESCRIPTION OF THE INVENTION

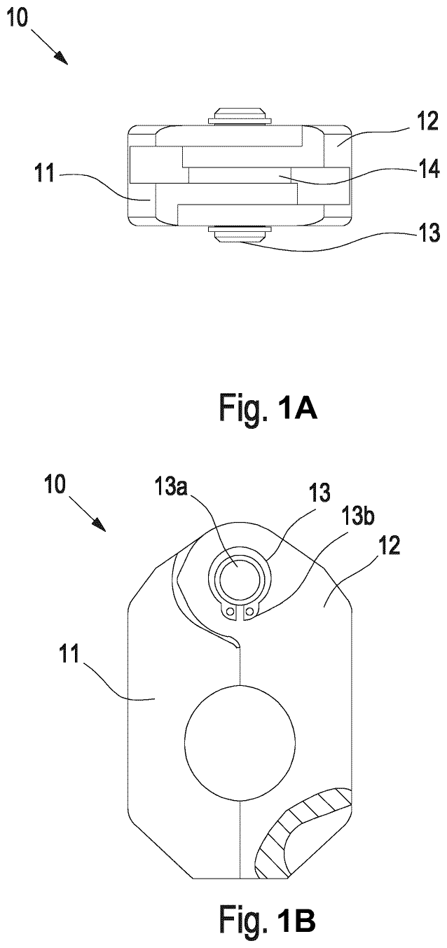

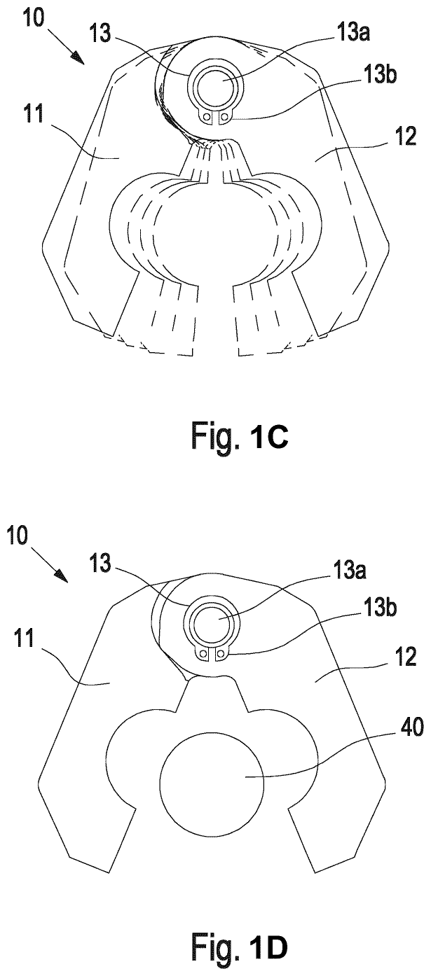

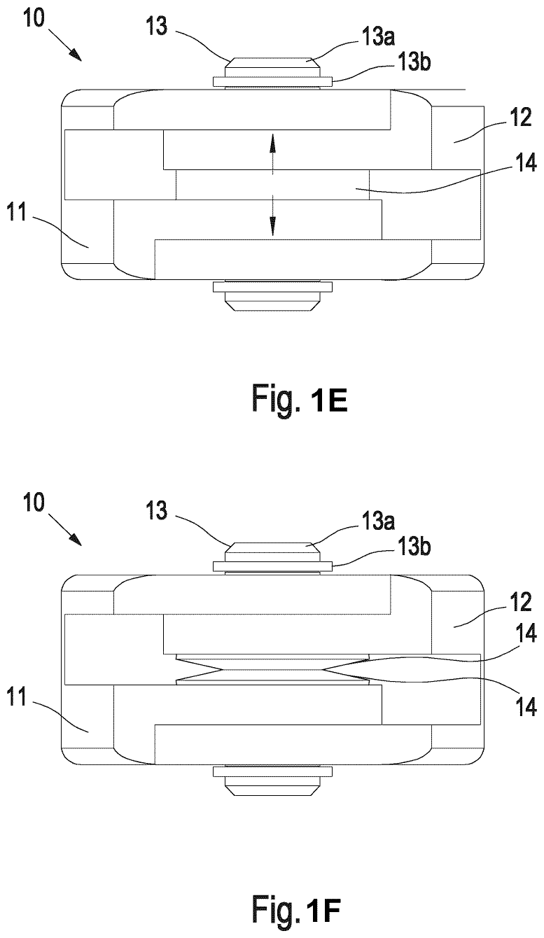

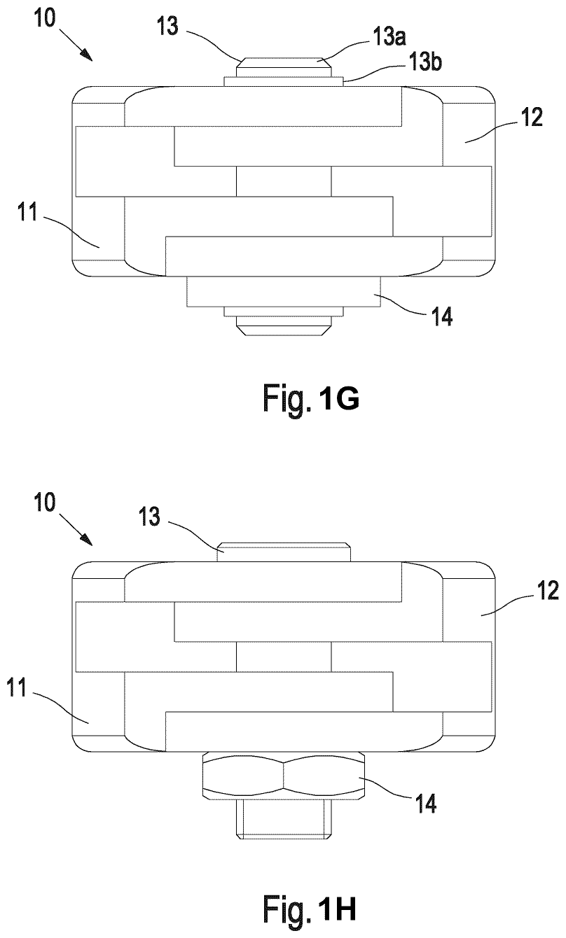

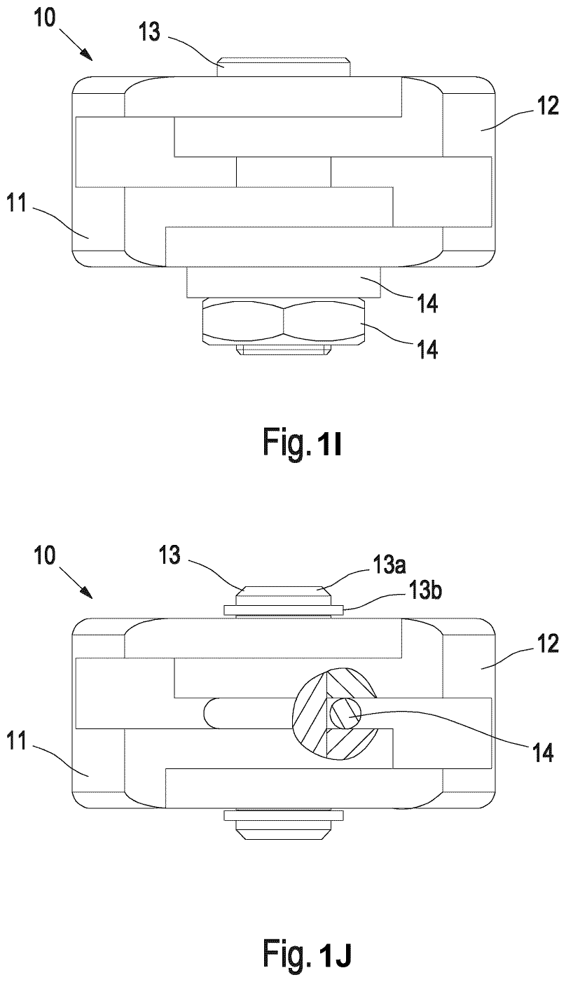

FIG. 1A shows a press ring 10 according to the invention for pressing a press fitting with a suitable pressing tool. The press ring 10 has two segments 11, 12, which can be moved from an open position to a closed position and are connected to each other by means of a connecting element 13. Furthermore, the press ring 10 has an adjustment element 14 between the two segments 11, 12. As can be seen in FIG. 1, the adjustment element 14 is arranged between the two segments 11, 12 and is in direct contact with the two segments 11, 12 in the axial direction. The adjustment element 14 allows the at least two segments 11, 12 to be moved to any position between an open position and a closed position and held there without force, without the press ring 10 having to be held in an open position by a user.

FIG. 1B shows the press ring 10 in the closed position. The two segments 11, 12 form an internal opening suitable for receiving a press fitting. As can be seen in FIG. 1B, the connecting element 13 has, in particular, an essentially cylindrical fastening element 13a, designed to be received in any through-opening of the two segments 11, 12, and an annular securing element 13b.

As shown schematically in FIG. 1C using some example positions, the press ring 10 can be set to any position between the open and closed position using the adjusting element 14. In particular, the adjusting element 14 is designed to generate an axial force along the connecting element 13, wherein the axial force presses an axial surface of the first segment 11 onto an axial surface of the second segment 12 in order to hold the two segments 11, 12 in the desired position by the friction of the first axial surface with the second axial surface. This is indicated in FIG. 1D by the two opposing axial arrows. The friction is adapted or dimensioned in such a way that a frictional connection or non-positive connection is created between the adjustment element 14 and the two segments 11, 12 to hold the two segments 11, 12 in any position between an open position and a closed position. The frictional force therefore counteracts the gravitational closing force and thus enables one-handed operation of the press ring 10 in particular.

As shown in FIG. 1D, the appropriately adjusted press ring 10 can then be placed around a press fitting 40 without having to apply additional force to hold the segments 11, 12 in the desired position. In particular, the friction generates a braking effect and prevents the segments 11, 12 from snapping back into the closed position. This enables simple and precise positioning of the press ring 10 on the press fitting 40. This therefore improves operability, in particular enables one-handed operation of the press ring 10 and improves the precision of the pressing process, as the press ring 10 is held in the set position by the adjustment element 14 until the press ring 10 has been positioned at a point on the press ring to be pressed. Here, the press ring 10 can be closed by the user applying a closing force.

In the following, identical or similar components are identified by identical reference numerals.

FIG. 1E shows an embodiment of the press ring 10 in which, as in FIG. 1A, the adjustment element 14 is arranged axially between the two segments 11, 12 and is in direct contact with the two segments 11, 12. The adjustment element 14 in FIG. 1E is preferably designed as a single preloaded spring element. The pre-tensioned spring element can, for example, be designed as an elastomer, a compression spring, a wave spring or a flat spring, in particular a disk-shaped flat spring. Preferably, the spring element is made of metal or a compressible or elastic material, such as plastic or another elastomer. As schematically indicated by the two arrows in FIG. 1E, the spring element 14 exerts an axial force along the connecting element 13 on the inner surface of the first segment 11 and an axial force pointing in the opposite axial direction on the inner surface of the second segment 12. The friction of the adjustment element with the inner surface of the first segment 11 and with the inner surface of the second segment 12 creates a frictional connection, which is designed to hold the two segments 11, 12 in any position without force.

FIG. 1F shows a further embodiment of the press ring 10 in which the adjustment element 14 is arranged axially between the two segments 11, 12 and is in direct contact with the two segments 11, 12. The adjustment element 14 in FIG. 1F is preferably designed as a plate spring. Preferably, the plate spring is made of a compressible or elastic material, such as plastic or metal. The plate spring 14 generates an axial force along the connecting element 13, wherein the axial force presses the axial surface of the first segment 11 onto the axial surface of the second segment 12 in order to hold the two segments 11, 12 in a desired position by the friction of the first axial surface with the second axial surface. The advantage of using a plate spring is that a high force can be achieved with a very short spring travel.

FIG. 1F shows an embodiment of the press ring 10 in which the adjustment element 14 is arranged axially between the first segment 11 and one end of the connecting element 13 and is in direct contact only with the first segment 11 in the axial direction. The adjustment element 14 in FIG. 1F is detachably fixed to the press ring 10 by a retaining ring 13b.

The adjustment element 14 can be designed as a pre-stressed spring element, for example as a disk spring, an elastomer, a compression spring, a wave spring or a flat spring, in particular a disk-shaped flat spring. Preferably, the above-mentioned spring element is made of metal or a compressible or elastic material, such as plastic or another elastomer. In the embodiment shown in FIG. 1G, the pre-stressed spring element 14 exerts an axial force on the outer surface of the first segment 11 and an axial force along the connecting element 13, which may in particular be designed as a bolt, on the second segment 12 of the press ring 10. Here too, friction acts in such a way that the two segments 11, 12 of the press ring are held frictionally engaged in any position between the open and closed position of the press ring 10.

FIG. 1H shows a further embodiment of the press ring 10 in which the adjustment element 14 is arranged axially between the first segment 11 and one end of the connecting element 13 and is in direct contact only with the first segment 11 in the axial direction. The adjusting element 14 in FIG. 1H is designed as a screw element, in particular as a screw nut, which is screwed onto an internal thread of the connecting element 13, which is designed as a bolt. Also in the embodiment shown in FIG. 1H, an axial force acts on the outer surface of the first segment 11 and an axial force acts along the bolt 13 on the second segment 12 of the press ring 10, both forces acting via the nut 14. The two segments 11, 12 of the press ring are thus held frictionally engaged in any position between the open and closed position of the press ring 10. The advantage of using the nut as adjustment element 14 is that the retaining ring 13b can be dispensed with as an additional fixing means.

FIG. 1I shows a further embodiment of the press ring 10, in which the adjustment element 14 is designed as a combination of a pre-stressed spring element, which is arranged axially between the first segment 11 and one end of the connecting element 13, and a nut, which is also arranged in the axial direction at the same end of the connecting element 13, in direct contact with the spring element. The pre-stressed spring element can, for example, be designed as a plate spring, an elastomer, a compression spring, a wave spring or a flat spring, in particular a disk-shaped flat spring. Preferably, the above-mentioned spring element is made of metal or a compressible or elastic material, such as plastic or another elastomer.

The nut and the pre-stressed spring element 14 exert an axial force on the outer surface of the first segment 11 and an axial force along the bolt 13 on the second segment 12 of the press ring 10. In this embodiment as well, the two segments 11, 12 of the press ring are thus held frictionally engaged in any position between the open and closed position of the press ring 10.

FIG. 1J shows a further embodiment of the press ring 10. The adjustment element 14 is designed as an O-ring, which surrounds the connecting element 13 and is arranged axially between the two segments 11, 12. The O-ring is therefore in direct contact with both segments 11, 12 of the press ring 10 in the axial direction. Furthermore, the O-ring 14 preferably has a preload. Preferably, the O-ring is made of a compressible or elastic material, such as plastic or rubber. Due to the axial force exerted by the O-ring along the connecting element 13 on the inner surfaces of the first segment 11 and on the inner surface of the second segment 12, the friction of the O-ring with the respective inner surfaces of the first segment 11 and the second segment 12 generates a frictional connection, which is designed to hold the two segments 11, 12 in any position between the open position and the closed position.

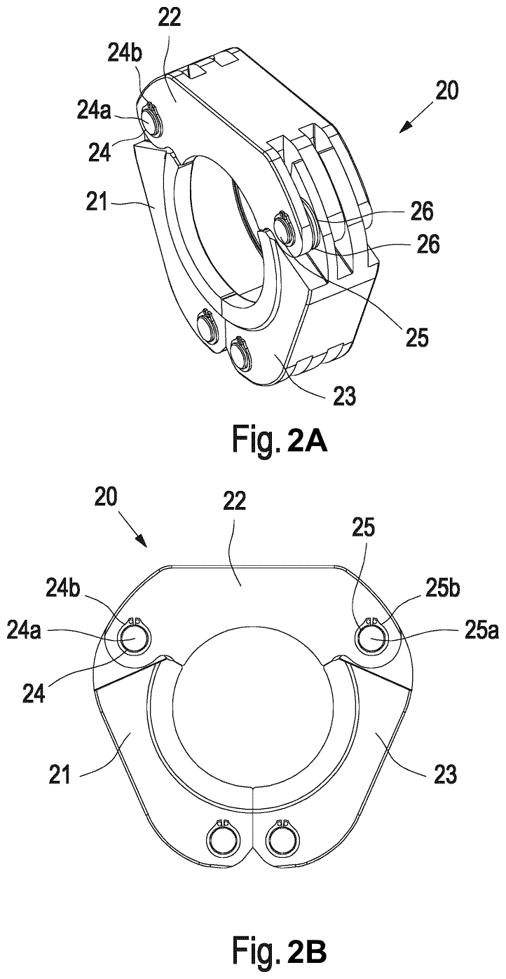

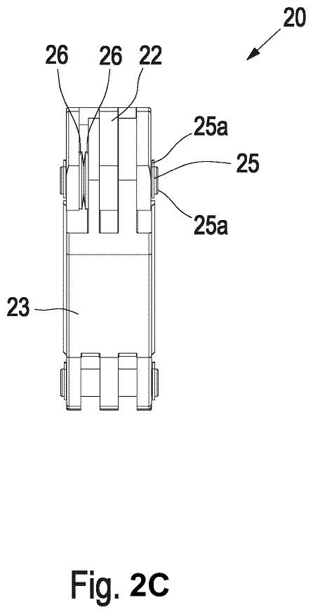

FIGS. 2A and 2B show an embodiment of the press collar 20 according to the invention. The press collar has three segments 21, 22, 23. Here, the first segment 21 is movably connected to the second segment 22 via a first connecting element 24 and can be moved from an open position to a closed position. The third segment 23 is movably connected to the second segment 22 from an open position to a closed position via a second connecting element 25. In the embodiment of the press collar 20 shown in FIG. 2, the connecting elements 24, 25 each have a cylindrical fastening element 24a and, in particular, two ring-shaped securing elements 24b arranged at opposite ends of the fastening element 24a. The second connecting element 25 also has a cylindrical fastening element 25a and, in particular, two ring-shaped securing elements 25b, which are arranged on opposite ends of the fastening element 25a. Preferably, the connecting elements 24, 25 are designed as bolts and the fastening elements 24b, 25b are designed as retaining rings.

Furthermore, the press collar 20 has an adjustment element 26, which is designed to adjust the third segment 23 to any position between the open position and the closed position. The adjustment element 26 is arranged between the second and third segments 22, 23 in direct contact only with the second and third segments 22, 23.

In the embodiment shown in FIGS. 2A, 2B, the adjustment element 26 is designed as a pre-stressed spring element, in particular as a plate spring. Alternatively, the adjustment element 26 can, for example, be designed as a compression spring, a wave spring, a flat spring, in particular a disk-shaped flat spring, an O-ring or an elastomer spring or an elastomer ring.

FIG. 2C shows a side view of the embodiment of the press collar 20 shown in FIGS. 2A, 2B with the disk spring 26 between the second and third segments 22, 23. The plate spring 26 is designed to generate an axial force along the connecting element 25, wherein the axial force presses an axial surface, in particular a first inner surface of the second segment 22, onto an axial surface, in particular a first inner surface of the third segment 23, in order to hold the third segment 23 in any position between the open and the closed position by frictional engagement.

Alternatively, in another embodiment, the adjustment element 26 may be arranged between the second segment 22 and one end of the connecting element 25 and thus only be in direct axial contact with the second segment 22 and the connecting element 25.

Furthermore, according to a further embodiment, the press collar can have at least one further adjustment element, which can be arranged either between the first and second segments 21, 22 and/or between the first segment 21 and one end of the first connecting element 24. In addition, the second adjustment element can either be the same as the first adjustment element 26 or of a different design.

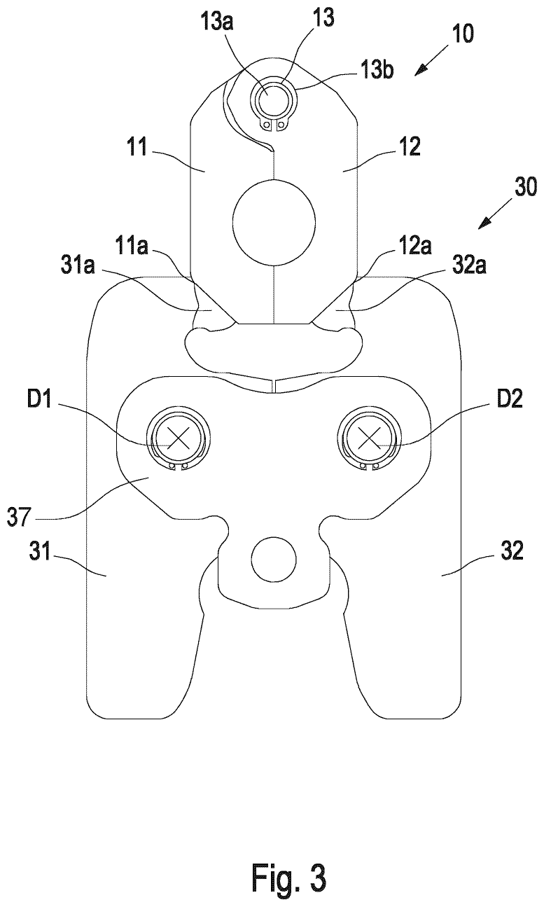

FIG. 3 shows an embodiment of a pressing tool 30 according to the invention with a press ring 10. The pressing tool 30 has two pressing jaws 31, 32. The pressing tool 30 further comprises a pair of connecting elements 31a, 32a, which are designed in terms of their shape, dimensions and position such that they are suitable for connection to a pair of receiving elements 11a, 12a of the press ring 10. In FIG. 3, the press ring 10 and the pressing tool 30 are shown in a closed position, in engagement with each other.

The first pressing jaw 31 is arranged to rotate about a first axis of rotation D1 and the second pressing jaw 32 is arranged to rotate about a second axis of rotation D2 and is connected to one another by a lug 37. The axes of rotation D1, D2 are designed in particular as bolts. The pressing jaws 31, 32 can be moved towards each other from an open position to a closed position for pressing. Furthermore, the pressing tool 30 has at least one adjustment element, the adjustment element being designed to adjust the first pressing jaw 31 and/or the second pressing jaw 32 to any position between the open position and the closed position.

In particular, the adjustment element is designed to generate an axial force along the respective axis of rotation, wherein the axial force presses an axial surface of the pressing jaw onto an axial surface of the lug 37, wherein the friction of the first axial surface with the second axial surface of the pressing jaw 31, 32 generates a frictional engagement and the pressing jaws 31, 32 are held in the desired position. The adjustment element can either be arranged between one of the two pressing jaws 31, 32 and the lug 37 or alternatively between one end of the respective axis of rotation D1, D2 and the lug 37. In the first case, the adjustment element is therefore in direct contact with the lug 37 and the respective pressing jaw 31, 32. In the second case, the adjustment element is only in direct contact with the lug 37. In both cases, the frictional connection ensures that the pressing jaws 31, 32 can not only be adjusted to any position between the open and closed position, but are also held in this position beyond that.

According to one embodiment of the present invention, the adjustment element can be designed as a spring element and in particular as a plate spring, a compression spring, a wave spring, a flat spring, in particular a disk-shaped flat spring, an O-ring or an elastomer, in particular an elastomer ring.

According to a further embodiment, the adjustment element can be designed as a screw element, whereby the screw element is detachably connected to the respective axis of rotation D1, D2, in particular at one end of the axis of rotation D1, D2.

All embodiments of the pressing tool 30 also have the features of the adjustment element of the press ring 10 described above and/or the press collar 20. In particular, the embodiments of the press ring 10, the press collar 20 and the pressing tool 30 can be freely combined with one another.

1. A press ring for pressing a press fitting, comprising:
at least two segments, which are movably interconnected by means of at least one connecting element, the segments being movable from an open position into a closed position; and
at least one adjustment element, the adjustment element being designed to adjust the at least two segments into any position between the open position and the closed position.

2. A press collar for pressing a press fitting, comprising:
at least three segments, wherein the first segment is movably connected to the second segment from an open position to a closed position via at least one first connecting element, and wherein the third segment is movably connected to the second segment from an open position to a closed position via at least one second connecting element, and
at least one adjustment element,
wherein the adjustment element is designed to adjust the first segment or the third segment to any position between the open position and the closed position.

3. The press collar according to claim 2, wherein the press collar has at least two adjustment elements.

4. The press ring or press collar according to claim 1, wherein the adjustment element is designed to generate an axial force along the connecting element, wherein the axial force presses an axial surface of the first segment onto an axial surface of the second segment in order to hold the two segments in the desired position by the friction of the first axial surface with the second axial surface.

5. The press ring or press collar according to claim 1, wherein the adjustment element is arranged between one of the two segments and one end of the connecting element.

6. The press ring or press collar according to claim 1, wherein the adjustment element is arranged between the two segments.

7. The press ring or press collar according to claim 1, wherein the adjustment element is a spring element and in particular a plate spring, a compression spring, a wave spring, a flat spring, an O-ring or an elastomer.

8. The press ring or press collar according to claim 1, wherein the adjustment element at least partially surrounds the respective connecting element.

9. The press ring or press collar according to claim 1, wherein the adjustment element is a screw element, the screw element being detachably connected to the connecting element and in particular being arranged at one end of the connecting element.

10. A pressing tool for pressing a press fitting in
particular by means of a press ring, comprising
two pressing jaws, wherein the first pressing jaw is arranged rotatably about a first axis of rotation and wherein the second pressing jaw is arranged rotatably about a second axis of rotation, wherein the axes of rotation are connected by a lug and
wherein the pressing jaws can be moved towards each other from an open position to a closed position for pressing, and
at least one adjustment element,
the adjustment element being designed to adjust the first pressing jaw and/or the second pressing jaw to any position between the open position and the closed position.

11. The pressing tool according to claim 10, wherein the adjustment element is designed to generate an axial force along the respective axis of rotation, wherein the axial force presses an axial surface of the pressing jaw onto an axial surface of the lug, wherein the friction of the first axial surface with the second axial surface of the pressing jaw is held in the desired position.

12. The pressing tool according to claim 10, wherein the adjustment element is arranged between one of the two pressing jaws and the lug.

13. The pressing tool according to claim 10, wherein the adjustment element is arranged between one end of the respective axis of rotation and the lug.

14. The pressing tool according to claim 10, wherein the adjustment element is a spring element and in particular a plate spring, a compression spring, a wave spring, a flat spring, in particular a disk-shaped plate spring, an O-ring or an elastomer.

15. The pressing tool according to claim 10, wherein the adjustment element at least partially surrounds the respective axis of rotation.

16. The pressing tool according to claim 10, wherein the adjustment element is a screw element, the screw element being detachably connected to the respective axis of rotation and in particular at one end of the axis of rotation.

17. A pressing device comprising an electric drive and a pressing tool according to claim 10, wherein the pressing tool is connected to the drive for moving the pressing jaws of the pressing tool.

18. A system comprising a press ring or a press collar according to claim 1 and a pressing device in particular having a drive.
